(19) United States
(12) Patent Application Publication
(10) Pub. No.: US 2012/0070314 A1
(43) Pub. Date: Mar. 22, 2012

(54) MICROPUMP

(75) Inventors: Jörg Mueller, Buchholz (DE); Régulo Miguel Ramirez Wong, Hamburg (DE)

(73) Assignee: Bayer Technology Services GMBH, Leverkusen (DE)

(21) Appl. No.: 13/320,790

(22) PCT Filed: May 11, 2010
(86) PCT No.: PCT/EP2010/002917

§ 371 Date: Nov. 16, 2011

(30) Foreign Application Priority Data
May 18, 2009 (DE) 10 2009 021 778.9

(51) Int. Cl. H02K 44/02; F04B 19/20

(52) U.S. Cl. 417/50; 417/92; 417/48

(57) ABSTRACT

The invention relates to a positive displacement pump, constructed in microsystem technology, which is preferably used as a vacuum pump.

The present invention generally concerns the field of micro-electromechanical systems (MEMS). The present invention relates to a positive displacement pump, constructed in microsystem technology, which is preferably used as a vacuum pump.

Positive displacement pumps are widespread in conventional vacuum technology and are used in a variety of ways. In the German industry standard DIN 28400, Part 2 (1989), the positive displacement pump is defined as a vacuum pump which, optionally by means of valves, sucks in, compresses and ejects the fluid to be delivered with the aid of pistons, rotors or discs which are insulated from one another with or without liquid.

One simple type of positive displacement pump is the so-called reciprocating pump, in which a piston or a diaphragm connected to a rod sucks a fluid in through an inlet valve in one half-period of the movement and ejects the fluid again through an outlet valve in the other half-period. An overview of conventional positive displacement pumps may be found, for example, in “Wutz Handbuch Vakuumtechnik: Theorie and Praxis” [Wutz Handbook of vacuum technology: theory and practice], edited by Karl Jousten, 9^{th} edition, published by Vieweg+Teubner Verlag, 2006.

Conventional pump systems cannot readily be used in microsystem technology. Microsystem technology combines methods of microelectronics, micromechanical engineering, microfluidics and micro-optics, as well as developments in computer science, biotechnology and nanotechnology, by combining developments and structures from these fields to form new systems. The dimensions of the function-determining structures lie in the micrometre range, which may be regarded as the boundary with nanotechnology.

Pumps in microsystem technology mainly use diaphragms for the compression mechanism, but sometimes also turbine wheels with an extremely high rotation speed or gas flows according to the jet or diffusion pump principle. A common feature of most of these pump mechanisms is that they only compress a more or less small part of the pump volume and the compression ratios are therefore relatively low, particularly for gases, or they only have a very short lifetime and high particle sensitivity. In the case of pumps for liquids, problems generally arise when they contain gas bubbles. These pumps are therefore hardly suitable in particular as vacuum pumps for reaching low pressures.

DE19719862A1, for example, describes a microdiaphragm pump. It comprises a pump diaphragm which can be moved by means of a drive unit into a first position and a second position, a pump body which is connected to the pump diaphragm, in order to define a pump chamber between them, as well as an inlet opening provided with a passive inlet valve and an outlet opening provided with a passive outlet valve. During the movement from the first position to the second position, the pump diaphragm increases the volume of the pump chamber by a stroke volume, and reduces the volume of the pump chamber by this stroke volume during the movement from the second position to the first position. One disadvantage with the pump is, inter alia, a large dead volume of the pump since the volume displaced during each pump stroke only amounts to a fraction of the volume of the pump chamber.

DE19922612A1 describes a micromechanical pump which is based on the principle of a peristaltic actuator that is formed by the tight coverage of a driving medium-filled annular cavity in a substrate with an electrically conductive diaphragm. One disadvantage is, inter alia, the use of the conductive diaphragm which is susceptible to mechanical stress and only has a limited lifetime owing to the high stress during use of the pump.

On the basis of the known prior art, it is therefore an object to provide a pump, for use in a microsystem, which has a small dead volume and a long lifetime. The desired pump should be capable of delivering both defined fluid volumes in the microlitre range and continuously.

According to the invention, this object is achieved by a micropump which operates according to the principle of a positive displacement pump and in which a liquid, which is driven by magnetic or electromagnetic forces, is used as the piston.

The present invention therefore relates to a micropump, comprising at least
an inlet,
an outlet,
a channel between the inlet and the outlet and
a piston located in the channel,
characterized in that the piston is a liquid which can be moved by means of an external field.

A fluid is sucked into the channel through the inlet of the micropump according to the invention, compressed in the channel and ejected again through the outlet.

The micropump according to the invention is based on the principle, also used on the macroscopic scale, of a liquid displacement pump. In contrast to these large systems, however, the pumping action of the micropump according to the invention is not carried out by mechanical driving of the liquid with only partial use of the liquid space as a collection space or pump volume; instead, a liquid which is driven in an external field by electromagnetic and/or magnetic forces is used as a piston.

In order to carry out this driving, the medium consists of an electrically conductive or magnetically permeable liquid, preferably having a low vapour pressure which determines the achievable base pressure. For example, metals which are liquid at the operating temperature in question, such as mercury or gallium, are suitable as electrically conductive liquids. It is nevertheless also possible to use conductive organic or other inorganic liquids having a sufficiently low resistivity and vapour pressure, and preferably also high chemical inertness. Inter alia, commercially available liquids comprising ferromagnetic nanoparticles may be used as magnetic liquids.

The liquid preferably has a high surface tension and a high interfacial tension relative to the channel walls, in order to avoid wetting thereof.

The driving for electrically conductive media is preferably carried out with the aid of the Lorentz force, which acts on moving charge carriers in a magnetic field. To this end permanent magnets or electromagnets, optionally provided with a yoke for screening and reduction of the magnetic reluctance, are arranged on one or both sides of the channel. Rare-earth magnets (RE magnets) are particularly suitable as permanent magnets. They are preferably used wherever high magnetic field strengths are required in combination with the smallest possible dimensions. RE magnets have a comparatively high coercive field strength and can therefore be used without problems even with high opposing fields.

When an electric current is passed through the piston, a force (the Lorentz force) is exerted on the moving charge carriers (electrons) in the magnetic field. The current-carrying piston is moved perpendicularly to the direction of the magnetic field lines and perpendicularly to the movement direction of the charged particles (electrons).

The contacting of the electrically conductive piston is carried out by means of contact layers, which are applied in or on the channel walls. Exposed thin films may also be used as contact layers.

When magnetically permeable liquids are used, the driving may be carried out by using a circulating magnetic field, for example induced by RE permanent magnets mounted on one or two discs rotating above and/or below the channel. Contacting of the liquid is not necessary in this case.

The channel is preferably linearly continuous without ends, particularly preferably annular. The cross section may be angled or continuous, that is to say without corners (for example elliptical or round). Preferably, the channel cross section is round or elliptical.

In a linearly continuous channel without ends, the inlet is preferably arranged directly behind the outlet so that the entire channel less the piston volume remains as a compressible volume. The channel may be constant in cross section. It may also narrow in the direction of the outlet (for example by eccentricity in the case of a circular channel cross section) in order to achieve a more rapid pressure increase in the channel.

The liquid piston is preferably moved in a circuit in a closed (micro)channel (for example ring, oval, racetrack). It fully seals the chamber volume from the channel walls. Instead of one piston and one inlet and outlet each, such systems may also be constructed with a plurality of pistons and a plurality of inlets and outlets. Instead of channel structures which are closed on themselves, it is also for example possible to use linear channel structures in pendulum operation with one or more inlets and outlets.

In order to achieve a high compression ratio, the compressed volume is compressed to virtually zero at the outlet. This is achieved by likewise using a liquid, which preferably consists of the same medium as the piston in order to avoid mixing, for sealing at the outlet. This liquid seal is not displaced by the incoming liquid piston until the two liquids have fully come together, i.e. the compressed medium has been pressed through the outlet entirely without residual volume in the pump channel. By means of the configuration of the drive and the shape of the channel in the outlet region, it is respectively possible for a part of the driving liquid to “tear off” at the end of the piston and remain behind as a seal before the outlet.

In the case of an electrically conductive liquid as the piston, the contact layers may be locally interrupted in the region of the outlet so that the driving force only acts when contact with the incoming piston takes place, i.e. the compressed volume is brought to zero by ejection through the outlet and “fusion” of the piston and the seal.

In the case of a magnetically permeable liquid, a reduced driving force at the outlet may for example be achieved by a magnetic short circuit, for example by a ferromagnetic material such as Ni at this position.

A channel constriction behind the outlet has a reinforcing effect and ensures a sufficiently high penetration force of the sealing medium so that it withstands the compressive pressure. This penetration force may also be achieved by contact with a local material which has a higher surface tension than the material of the channel. This contact is then interrupted again after penetration, for example by this constriction in the channel and suitably shaped channel structures, so that a part of the medium remains behind as a seal.

In order to prevent the sealing or driving liquid from entering the inlet and in particular outlet valves, micro- or nanoporous structures with a low surface energy (little or no wetting) are preferably integrated there, which the liquid medium (sealing, piston) cannot enter owing to the repulsive capillary forces and the high interfacial tension. These structures could be introduced both laterally and vertically. In the case of lateral arrangement, it is particularly advantageous to arrange the inlet valves on the inside of a curve, and the outlet structures on the outside, since the centrifugal forces can thereby additionally contribute to the suction and ejection processes.

The structures of the pump according to the invention, like many microsystems, are preferably produced in a silicon-glass technology. It is also conceivable to make the structures of the pump according to the invention in a silicon-silicon or glass-glass technology.

The production of structures in microsystems is known to the person skilled in the art of microsystem technology. Microfabrication techniques are, for example, described and illustrated in the book “Fundamentals of Microfabrication” by Marc Madou, CRC Press Boca Raton Fla. 1997 or in the book “Mikrosystemtechnik für Ingenieure” [Microsystem technology for engineers] by W. Menz. J. Mohr and O. Paul, Wiley-VCH, Weinheim 2005. A more detailed description of silicon-silicon technology may, for example, be found in Q.-Y. Tong, U. Gösele: Semiconductor Wafer Bonding: Science and Technology; The Electrochemical Society Series, Wiley, New York (1999). With regard to glass-glass technology, reference may be made by way of example to the following publications: J. Wie et al., Low Temperature Glass-to-Glass Wafer Bonding, IEEE Transactions on advanced packaging, Vol. 26, No. 3, 2003, pages 289-294; Duck-Jung Lee et al., Glass-to-Glass Anodic Bonding for High Vacuum Packaging of Microelectronics and its Stability, MEMS 2000, The Thirteenth Annual International Conference on Micro Electro Mechanical Systems, 23-27 Jan. 2000, pages 253-258.

Microsystem technologies are fundamentally based on the structuring of silicon or glass substrates with a high aspect ratio (for example narrow trenches (˜μm) of great depth (˜100 μm)) with structuring accuracies in the micrometre range using wet chemical, preferably plasma etching processes combined with sodium-containing glass substrates adapted in terms of their thermal expansion coefficient (for example Pyrex®), which are provided with simple etched structures and preferably connected to one another with a hermetic seal directly by so-called anodic bonding, or alternatively with a thin Au layer functioning as a solder alloy (AuSi).

Metal structures with a high aspect ratio can be produced by electrolytic growth in thick photoresists (>100 μm) with comparable accuracy (UV-LIGA). By using thin-film technologies such as high vacuum evaporation and sputtering, PVD processes or chemical vapour deposition (CVD processes) preferably in a plasma, in combination with photolithography and etching techniques, functional layers such as metallizations, hydrophobic or hydrophilic surfaces and functional elements such as valve seals and diaphragms, heating elements, temperature, pressure and flow sensors can be integrated on these substrates in a fully process-compatible technology.

The pump is preferably constructed in a silicon-glass or silicon-glass-silicon-substrate stack, in which case the channel and valve structures should preferably be produced in silicon owing to its simpler and more precise properties of structuring by means of chemical and physical methods. The electrical interconnects may, for example, be deposited by thin-film methods. Particularly for relatively large batch runs, patterning by methods of polymer shaping technologies such as injection moulding, hot stamping etc. are advantageous. For the optionally additional locally differing adjustment of defined surface energies, coatings by deposition e.g. in a plasma (plasma polymerization, PECVD, sputtering) or by vapour deposition (self-organizing monolayers (SAM), high vacuum evaporation) may be used in combination with photolithography and etching or lift-off techniques.

The micropump according to the invention is preferably suitable as a vacuum pump in a microsystem.

The present invention therefore also relates to the use of the micropump according to the invention as a vacuum pump in a microsystem, for example in a micro mass spectrometer, as described for example in the article “Complex MEMS: A fully integrated TOF micro mass spectrometer” published in Sensors and Actuators A: Physical, 138 (1) (2007), pages 22-27.

The invention will be explained in more detail below with the aid of figures, but without being restricted thereto.

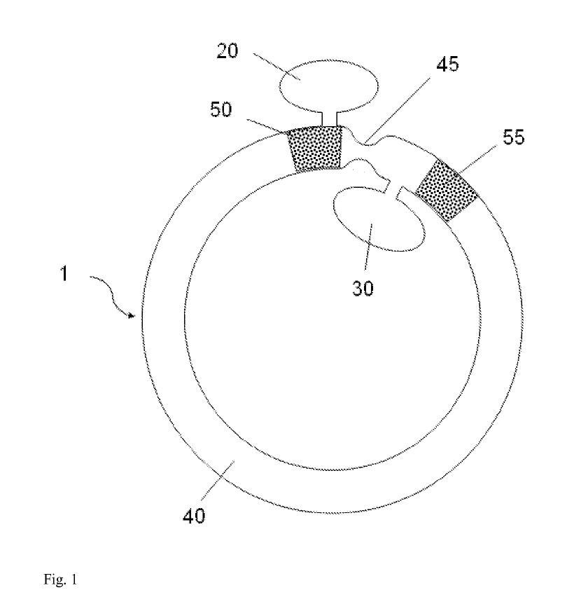

FIG. 1 schematically shows by way of example a cross section of a micropump 1 according to the invention in plan view. It comprises an inlet 30 and an outlet 20, which are connected to one another by means of a channel 40. The channel 40 is configured linearly continuously without ends, as a ring. It has a constriction 45 between the inlet 30 and the outlet 20. In the channel, there is an electrically conductive or magnetically permeable liquid 50, 55, which is used as a piston 55 and as a seal 50.

During operation of the pump, the constriction 45 facilitates separation of the electrically conductive or magnetically permeable liquid into a piston 55 and a seal 50.

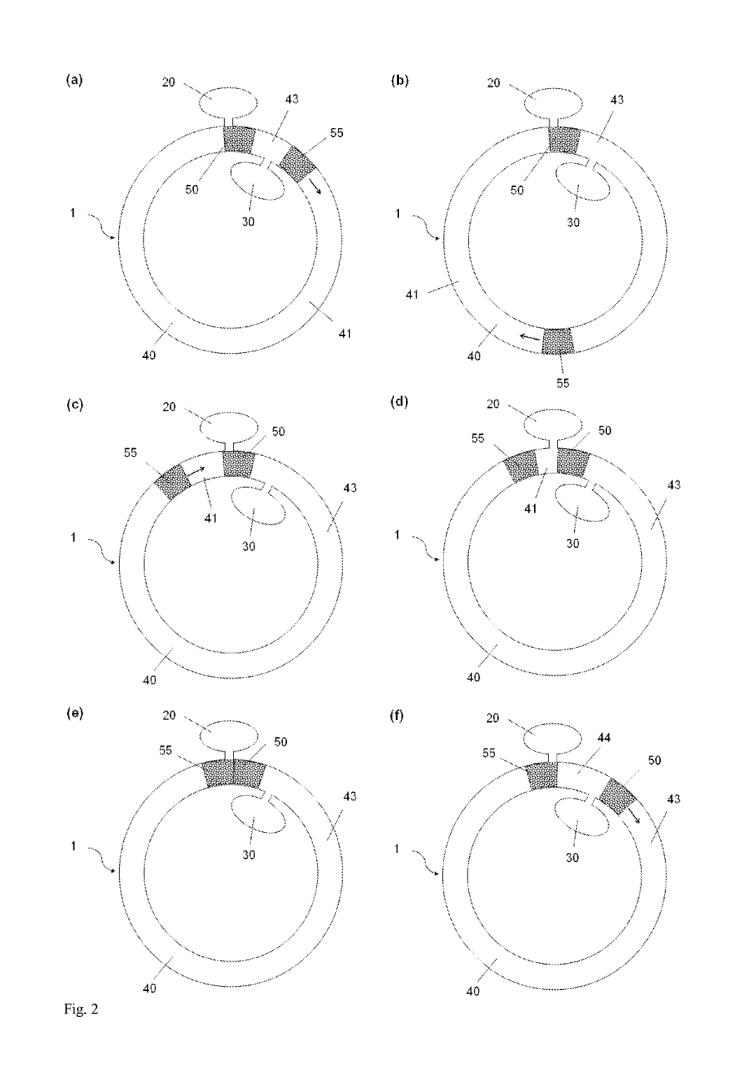

FIGS. 2 (a) to (f) show a schematic representation of the micropump according to the invention of FIG. 1 in operation. To simplify the drawing, the constriction 45 is not shown in FIG. 2. In the starting state (a), the channel 40 is divided by the piston 55 and the seal 50 into two sections having an internal space 41 and an internal space 43. The internal space 41 is closed. The fluid contained in the internal space 41 is compressed by movement of the piston 55 in the anticlockwise direction (represented by the arrow). The seal 50 seals the internal space 41 from the outlet. Expansion of the internal space 43 simultaneously takes place owing to the movement of the piston 55 in the anticlockwise direction. As a result of this, fluid is sucked through the inlet 30 into the internal space 43. In FIG. 2 (b), the internal spaces 41 and 43 are approximately of equal size. In FIG. 2 (c), the internal space 41 is increasingly reduced and the fluid contained in the internal space 41 is correspondingly compressed. In FIG. 2 (d), the seal 50 no longer closes the path to the outlet. The compressed fluid is ejected from the internal space 41 through the outlet 20. In FIG. 2 (e), the liquid portions which formed the piston 55 and seal 50 in FIGS. 2 (a) to (e) are combined into one liquid portion. The internal space 43 has reached its maximum size and is filled with fluid through the inlet. In the following pump cycle (see FIG. 2 (f)), the liquid plugs are separated: the front region 50, which previously fulfilled the function of the seal, becomes the piston, and the rear region 55 becomes the seal. The internal space 43 is compressed. A new internal space 44 is formed, into which fluid is sucked through the inlet 30.

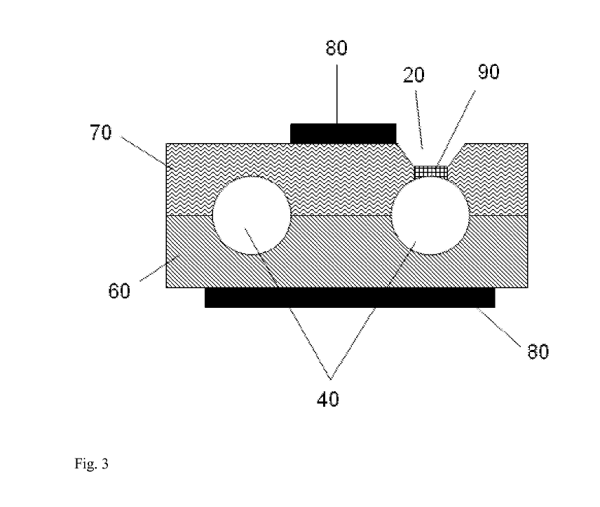

FIG. 3 schematically shows a micropump according to the invention in cross section from the side. The channel 40 has a round cross-sectional profile. It is formed in a substrate 60 and a cover 70. An outlet 20 and an inlet (not shown here) are formed in the cover. A porous mesh 90 is intended to prevent the electrical liquid, which is contained in the channel and acts as a seal and a piston, from being pressed through the outlet. Magnets 80 are arranged above and below the channel.

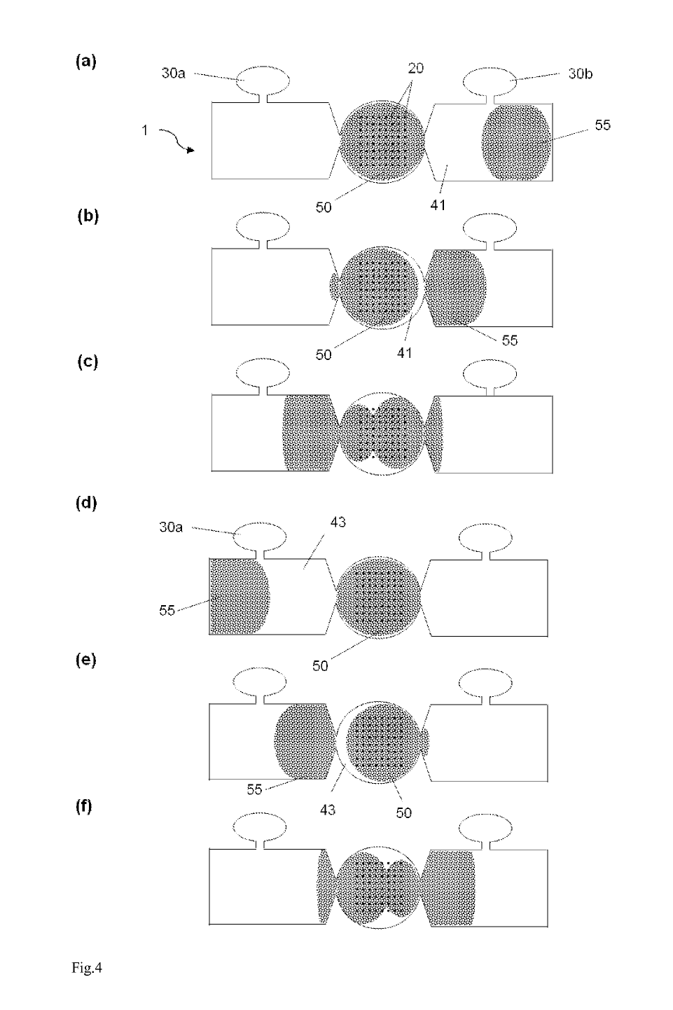

FIGS. 4 (a) to (f) show a micropump 1 according to the invention in pendulum operation. This embodiment comprises three chambers, which are connected to one another by means of two constrictions. The outer chambers comprise an inlet 30a and 30b, respectively. The central chamber comprises an outlet 20 in the form of narrow channels, through which the liquid seal 50 cannot pass. In a first step (FIG. 4 (a)) a liquid piston 55 moves in the direction towards the outlet 20. The internal space 41 is thereby increasingly reduced and the fluid contained in it, which has entered the internal space through the inlet 30b, is increasingly compressed. In FIG. 4 (b), the pressure in the internal space 41 exceeds a limit value and the seal 50 is pressed into the left-hand chamber. The outlet is therefore opened, and the compressed fluid can escape (FIG. 4 (c)). In FIG. 4 (d), the former piston and the former seal change their functions. Now, by movement of the piston in the left-hand chamber in the direction of the outlet 20, the fluid contained in the internal space 43 is increasingly compressed (FIG. 4 (e)). The seal 50 is finally pressed through the constriction into the right-hand chamber, and the fluid in the internal space 43 can escape through the uncovered outlet (FIG. 4 (f)).

### REFERENCES

1 Micropump
20 Outlet
30 Inlet
40 Channel
41 Internal space
43 Internal space
44 Internal space
45 Constriction
50 Liquid seal
55 Liquid piston
60 Substrate
70 Cover
80 Magnets
90 Porous mesh

1. Micropump, comprising at least
an inlet,
an outlet,
a channel between the inlet and the outlet and
a piston located in the channel,
wherein the piston is a liquid which can be moved by means of an external field.

2. Micropump according to claim 1, wherein the liquid is electrically conductive and can be moved perpendicularly to an external magnetic field as a result of a Lorentz force, which acts on moving charge carriers in the liquid.

3. Micropump according to claim 1, wherein the liquid is magnetically permeable and can be moved with the aid of a circulating external magnetic field.

4. Micropump according to claim 1, wherein the channel is linearly continuous without ends.

5. Micropump according to claim 1, which further comprises means for separating the liquid into two parts during operation of the pump, one part functioning as a piston and the other part as a seal.

6. Micropump according to claim 5, wherein the means comprise a constriction between the outlet and the inlet.

7. Micropump according to claim 5, wherein the means comprise micro- or nanoporous structures.

8. A microsystem comprising a micropump according to claim 1.
